(19) United States
(12) Patent Application Publication
(10) Pub. No.: US 2024/0429507 A1
(43) Pub. Date: Dec. 26, 2024

(54) Battery Pack comprising a Seal Unit

(71) Applicant: Robert Bosch GmbH, Stuttgart (DE)

(72) Inventors: Peter Kunert, Lichtenstein (DE); Stefan Schmid, Sindelfingen (DE); Thilo Koeder, Gerlingen (DE); Thorsten Droigk, Tuebingen (DE)

(21) Appl. No.: 18/746,287

(22) Filed: Jun. 18, 2024

(30) Foreign Application Priority Data
Jun. 20, 2023 (DE) 10 2023 205 746.8

(51) Int. Cl. H01M 50/184; H01M 50/119; H01M 50/121

(52) U.S. Cl. CPC H01M 50/184; H01M 50/119; H01M 50/121; H01M 2220/20

(57) ABSTRACT

A battery pack, in particular to an interchangeable battery pack includes a housing. The housing includes at least two housing portions and a sealing unit for sealing the housing. The sealing unit includes at least one sealing element received in a receiving space between the housing portions. The sealing element includes exactly two seal lips.

This application claims priority under 35 U.S.C. § 119 to patent application no. DE 10 2023 205 746.8, filed on Jun. 20, 2023 in Germany, the disclosure of which is incorporated herein by reference in its entirety.

### BACKGROUND

DE 10 2021 206 828 A1 describes a battery pack comprising a lip seal ring.

### SUMMARY

The disclosure relates to a battery pack, in particular to an alternating battery pack comprising a housing, wherein the housing comprises at least two housing portions and a sealing unit for sealing the housing and wherein the sealing unit comprises at least one sealing element received in a receiving space between the housing portions. It is proposed that, the sealing element comprise exactly two seal lips. Advantageously, the sealing element, in particular for housing portions with thin wall thicknesses, can ensure that little or no significant deformation of the housing portions occurs due to the sealing element, and the surface compression is optimized as a result.

The battery pack is in particular part of a system consisting of the battery pack and a consumer, wherein the consumer is powered via the battery pack during operation. The battery pack is, e.g., designed as a battery pack for a hand-held tool or as an electric bike. The battery pack is designed in particular as an exchangeable battery pack, which is preferably designed to be detachable from the consumer without tools. Alternatively, it is also conceivable that the battery pack be fixedly mounted or integrated into the housing of the consumer. In this context, the expression “detachment without tools” is also understood to mean detachment via a lock, e.g. a bicycle lock. The lock can in this case be designed to be actuatable, e.g. via a key or an electrical actuator. The battery pack is in particular designed to be connectable to a charging apparatus for charging the battery pack. Alternatively or additionally, the battery pack can also be designed to be chargeable when connected to the consumer.

The consumer can in particular be designed as a gardening device, e.g. a lawnmower or hedge shears; as a domestic device, e.g. an electric window washer or handheld vacuum; as a hand-held tool, e.g. an angle grinder, screwdriver, drill, hammer drill, etc.; as an electrical transportation mechanism, e.g. an electric bike in the form of a pedelec or an e-bike; as an e-scooter; or as a measurement tool, e.g. a laser measuring device. It is also conceivable that the consumer be designed as another (in particular portable) device, e.g. worksite lighting, a suction device, or a worksite radio.

At least one battery cell is arranged in the housing of the battery pack. The housing of the battery pack is preferably designed as an outer housing. The battery pack, in particular the housing of the battery pack, can be designed to be releasably connectable to the consumer and/or a charging apparatus via a mechanical interface, or it can be fixedly connected. The housing preferably comprises at least one housing portion, which is designed as an outer housing portion. The outer housing portion delimits the battery pack in an outward direction and can be touched by a user. The housing can further comprise at least one inner housing portion, which is completely enclosed by the at least one housing portion. The housing portions are preferably connected to each other in a frictional and/or interlocking manner. This connection can, e.g., be performed via a screw connection, a clip connection, or another type of connection known to the skilled person.

The battery pack preferably comprises a cell holder for receiving the battery cells. The cell holder of the battery pack is in particular designed as a housing portion, preferably as an inner housing portion. However, it is also conceivable that the cell holder be partially or completely designed as an outer housing portion. The housing of the battery pack can comprise one or multiple cell holders. The housing portions are connected to each other in a frictional, interlocking, and/or bonded manner. The cell holder can also comprise sleeve-shaped inserts, which in turn are associated with the protection unit and comprise at least one reinforcing element and/or a weakening element. The cell holder is preferably made of a plastic, in particular a thermoplastic. The cell holder is preferably made of a temperature-resistant plastic, preferably a fiber-reinforced plastic. Alternatively, it is also conceivable that the cell holder be made of a metallic material. The cell holder has in particular an integral or one-piece design. Other materials are also conceivable, e.g. ceramics. In the context of the present application, the term “one-piece” is understood to mean a component that is designed to be made of one piece and not made of multiple components connected to one another in a bonded, and/or frictional, and/or interlocking manner. Accordingly, a one-piece component consists of a single material. In the context of the present application, the term “integral” is in particular understood to mean multiple components connected to one another in a bonded manner, e.g. via 2K injection molding or a bonded connection. Therefore, an integral component can consist of one or multiple materials. Alternatively, it is also conceivable that the cell holder be designed in multiple parts, wherein the different parts are connected to each other in a frictional and/or interlocking manner. The battery pack can comprise one or multiple cell holders which are arranged adjacently and/or consecutively.

The battery pack can be connected to the consumer in a frictional and/or interlocking manner via a mechanical interface. Advantageously, the mechanical interface comprises at least one actuating element, via which the connection of the battery pack to the consumer and/or the charging apparatus is releasable. The actuating element can, e.g., be designed as a lock, a button, a lever, or a button. The actuating element can be arranged on the battery pack or on the consumer. The mechanical interface can further comprise guide elements for guiding the battery pack during the connection process and/or centering elements for centering the battery pack during the connection process.

The battery pack further comprises at least one electrical interface, via which the battery pack is electrically connectable to the consumer and/or the charging apparatus. The battery pack can, e.g., be charged and/or discharged via the electrical connection. Alternatively or additionally, it is also conceivable that information from the battery pack be communicable to the consumer via the electrical interface, and vice versa. The electrical interface is preferably designed as a contact interface, where the electrical connection occurs via a physical contact of at least two conductive components. The electrical interface preferably comprises at least two electrical contact elements. In particular, one of the electrical contact elements is designed as a positive contact, and the other electrical contact element is designed as a negative contact. The electrical interface can further comprise at least one additional contact designed to transmit additional information to the consumer and/or the charging apparatus. The additional contacts can be designed as signal contacts, coding contacts, temperature contacts, bus contacts, etc. The electrical contact elements can, e.g., be designed as spring contact elements in the form of contact tulips or as flat contacts in the form of contact blades. Alternatively or additionally, the electrical interface can comprise a secondary charging coil element for inductive charging. The mechanical interface and the electrical interface can be designed to be integrated or separate from one another.

Furthermore, the battery pack preferably comprises electronics. The electronics can, e.g., comprise a printed circuit board, a computing unit, a control unit, a transistor, a capacitor, and/or a storage unit. Additionally, or alternatively, it is also conceivable that information be determined by the electronics. The electronics are designed to control or regulate the battery pack and/or the consumer. In particular, electronics comprise a BMS (battery management system) designed to monitor the battery pack. In particular, the BMS is designed to prevent overcharging and/or deep discharge of the battery pack. The BMS is preferably designed to correctly balance cells. The electronics can also comprise one or more sensor elements, e.g. a temperature sensor, for determining the temperature within the battery pack, or a motion sensor for determining movements. The electronics can alternatively or additionally comprise a coding element, e.g. a coding resistor. The electrical contact elements of the electrical interface for the battery pack can be arranged on the printed circuit board of the electronics, or be connected to the printed circuit board. In the context of the present application, a printed circuit board is intended to be a circuit board comprising an organic or inorganic substrate, e.g. IMS. The printed circuit board can be designed as a rigid printed circuit board or a flexible printed circuit board. In addition, the printed circuit board can be a populated or an unpopulated printed circuit board. The printed circuit board can comprise a single layer or be designed in multiple layers.

A battery cell can be designed as a galvanic cell which has a structure in which one cell pole comes to lie at one end and a further cell pole comes to lie at an opposite end. In particular, the energy storage cell has a positive cell pole on one end face and a negative cell pole on the opposite end face. Preferably, the battery cells are designed as NiCd or NiMh, particularly preferably as lithium-based battery cells or Li-ion battery cells. Alternatively, it is also conceivable that, by way of example, the battery cell be designed as a pouch cell or as a prismatic cell. The battery voltage of the battery pack is typically a multiple of the voltage of a single battery cell and results from the circuit (parallel or serial) of the battery cells. In common battery cells with a cell voltage of 3.6 V, voltage classes of, by way of example, 3.6 V, 7.2 V, 10.8 V, 14.4 V, 18 V, 36 V, 54 V, 108 V etc., are therefore produced. A battery cell is preferably designed as an at least substantially cylindrical round cell, wherein the cell poles are arranged at the ends of the cylindrical shape.

The sealing element is in particular made of a plastic, preferably an elastic plastic. The sealing element is in particular elastically designed such that the sealing element, in particular the seal lips, are designed to be deformed and/or compressed in the mounted state. In particular, the sealing unit comprises a single sealing element between two respective housing portions. Preferably, the sealing element is made of a rubber. The sealing element preferably has a one-piece design. In the mounted state, the sealing element is in particular arranged in the receiving space and is compressed such that no moisture or spray water can enter the interior of the battery pack through the receiving space. The sealing element can be designed as a seal ring.

The seal lips preferably extend substantially parallel to each other. The seal lips are arranged on a base body that extends substantially along a joining surface between the housing portions. The seal lips are preferably made of the same material.

It is also proposed that the sealing element be arranged radially between the first housing portion and the second housing portion. As a result, an optimal sealing action can be ensured in an advantageous manner.

It is further proposed that the first housing portions be designed as an end cap, and the second housing portion as a particularly tubular base body. In particular, the end cap in this case substantially terminates the base body on one side.

It is also proposed that the second seal lip have a lower height than the first seal lip. As a result, the pressure on the housing can be reduced by the sealing unit in an advantageous manner. The second seal lip has a height, in particular in a range between 50% and 99% of the height of the first seal lip, preferably in a range between 75% and 95% of the height of the first seal lip. Preferably, the height of the second seal lip is less than the height of the first seal lip by several tenths of a mm, e.g. 0.2 to 0.3 mm.

It is further proposed that the second seal lip have a smaller width than the first seal lip. As a result, the method can be further optimized in an advantageous manner. The width can be a width of the respective seal lip at the root, e.g. on the base body of the sealing element. Alternatively, the width can also be a half-width of the seal lip in the middle of the respective seal lip. In particular, the second seal lip has a width reduced by at least 5%, preferably at least 10%, preferentially by at least 25%.

It is further proposed that a distance between the first seal lip and the second seal lip be designed to be smaller than a width of the first seal lip. As a result, the pressure applied to the housing can be further optimized in an advantageous manner. In particular, the distance is designed such that the seal lips are always at a distance from one another in the mounted state, even if they are bent.

It is also proposed that the receiving space in the region of the sealing element, in particular in the region of the first seal lip, have a constant size. In particular, the sealing element, preferably the first seal lip, is enlarged in some areas. As a result, the contact pressure of the sealing element on the housing can be optimally adjusted in an advantageous manner.

It is further proposed that the enlargement be designed to be in a range between 5% and 50%, preferably in a range between 10% and 20%. As a result, the sealing element can be further optimized in an advantageous manner.

It is further proposed that the second seal lip vary in size. As a result, the sealing element can be further optimized in an advantageous manner. Alternatively, it is also conceivable that the second seal lip be designed to be constant in size.

It is further proposed that the sealing element comprise a connecting element for a frictional and/or interlocking connection between the sealing element and the first housing portion and/or the second housing portion. As a result, the mounting and positioning of the sealing element can be improved in an advantageous manner. The housing of the battery pack preferably comprises at least one corresponding connecting element. The connecting element and the sealing element are preferably designed to be integral.

It is further proposed that the second housing portion be made of a metallic material and have a thickness of less than 1.1 mm, preferably less than 0.8 mm. As a result, a particularly compact battery pack can be provided in an advantageous manner.

It is further proposed that the second housing portion be made of a plastic and have a thickness of less than 2.0 mm, preferably less than 1.5 mm. As a result, a particularly light battery pack can be provided in an advantageous manner.

### BRIEF DESCRIPTION OF THE DRAWINGS

Further advantages will emerge from the following description of the drawings. The drawings, the description, and the claims contain numerous features in combination. The person skilled in the art will appropriately also consider the features individually and combine them into additional advantageous combinations.

Shown are:

FIG. 1 a perspective view of an electric bike comprising a battery pack according to the disclosure;

FIG. 2 a perspective view of the battery pack;

FIG. 3 a cross-section through a housing portion of the battery pack;

FIG. 4 a section through a sealing element of the battery pack;

FIG. 5 an overhead view of the sealing element of the battery pack according to FIG. 4.

### DETAILED DESCRIPTION

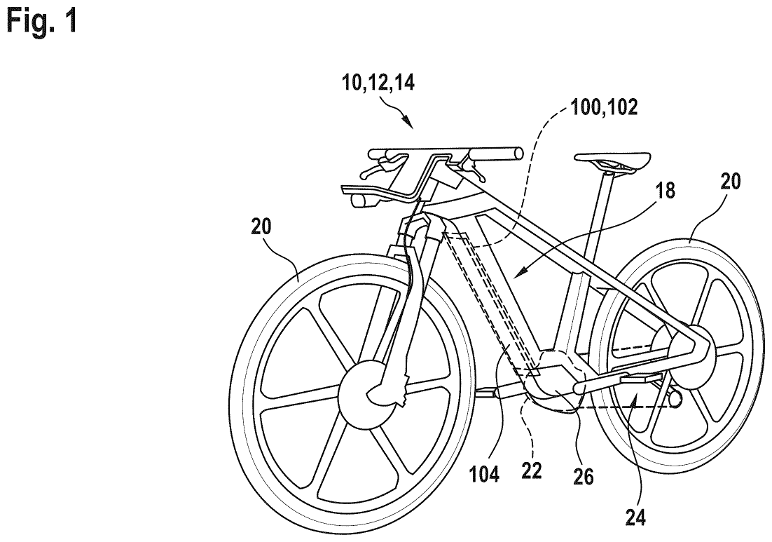

FIG. 1 shows a side perspective view of a consumer 10 comprising a battery pack 100. The consumer 10 is, by way of example, designed as an electrically driven transportation mechanism 12, in particular as an electric bike 14. The electric bike 14 can, e.g., be designed as a pedelec or an e-bike.

The electric bike 14 comprises a frame 18 or a bike frame. Two wheels 20 are connected to the frame 18. The consumer 10 also comprises a drive unit 22 having an electric motor. The electric motor is preferably designed as a permanent magnet-excited, brushless DC motor. The electric motor is, e.g., designed as a mid-drive motor, wherein a hub motor or the like is also conceivable.

The drive unit 22 comprises a control unit (not shown) designed to control or regulate the electric bike 14, in particular the electric motor. The electric bike 14 comprises a pedal crank 24. The pedal crank 24 is connected to a pedal crankshaft (not shown).

The control unit and the drive unit 22 comprising the electric motor and the pedal crankshaft are arranged within a drive housing 26 connected to the frame. The drive movement of the electric motor is preferably transmitted to the pedal crankshaft via a transmission (not shown), wherein the magnitude of the assistance by the drive unit 22 is controlled or regulated via the control unit.

The consumer 10 is electrically and mechanically connected to a battery pack 100, which is designed to provide the drive unit 22 with energy. The battery pack 100 is, by way of example, designed as an interchangeable battery pack 102. In the connected state, the battery pack 100 is, by way of example, fully received within the frame 18 of the electric bike 14. The connection can be performed via an axial insertion of the battery pack 100 into the lower tube of the frame 18, or by laterally pivoting the battery pack 100 into the frame 18. Alternatively, it is also conceivable that the battery pack 100 be designed such that the battery pack 100 is attachable to an outer side of the frame 18.

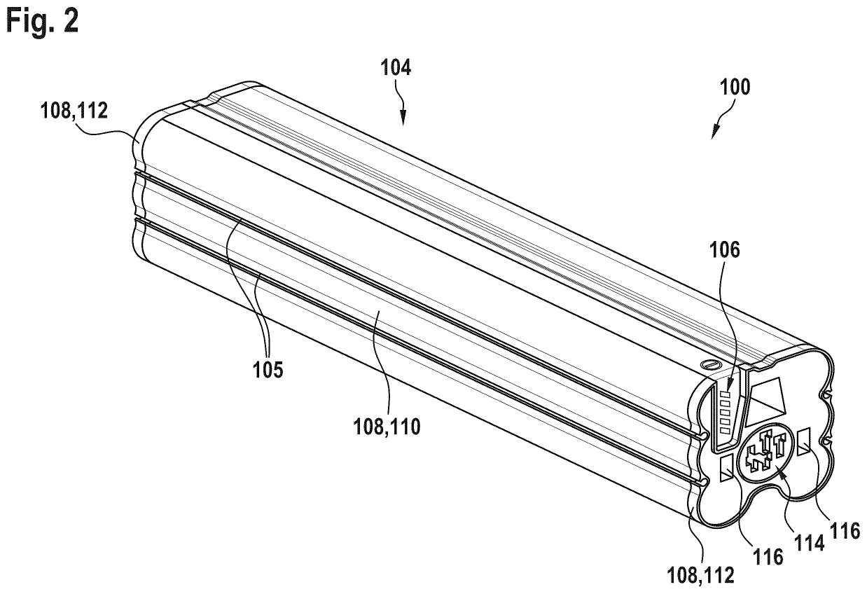

FIG. 2 shows a perspective view of the battery pack 100. The battery pack 100 comprises a housing 104 designed as an outer housing. The housing 104 of the battery pack 100 is, by way of example, also designed to partially terminate at the frame 18 of the electric bike 14 when in an attached state. This is performed via an aperture (not shown in FIG. 2) which can, e.g., be connected to the housing 104 via the longitudinal grooves 105.

The battery pack 100 comprises a charge level indicator 106, which is arranged on the housing 104 of the battery pack 100 and designed to indicate the state of charge of the battery pack 100. The charge level indicator 106 is in this case connected to electronics (not shown) of the battery pack. The electronics are arranged within the housing 104 of the battery pack 100 and comprise, by way of example, a battery management system.

The housing 104 comprises a housing portion 108 which is, by way of example, designed in the form of a tubular base body 110 extending substantially the entire length of the battery pack 100.

The housing 104 of the battery pack 100 further comprises two additional housing portions 108, by way of example in the form of connection plates 112. The connection plates 112 are, by way of example, also made of a plastic, in particular a hard plastic. The connection plates 112 are, by way of example, connected to the tubular base body 110 of the battery pack 100 in a frictional and/or interlocking manner, in particular a screw connection. The connection plates 112 in this case form end caps that terminate the face of the base body 110.

The first connection plate 112 comprises a locking unit (not shown), which is connectable to a corresponding locking unit (not shown) of the electric bike 14. The second connection plate 112 comprises an electrical interface 114 comprising a socket for electrically connecting the battery pack 100 to the electric bike 14. The second connection plate 112 further comprises, by way of example, three connection and/or centering elements 116 for connecting the battery pack 100 to the electric bike 14.

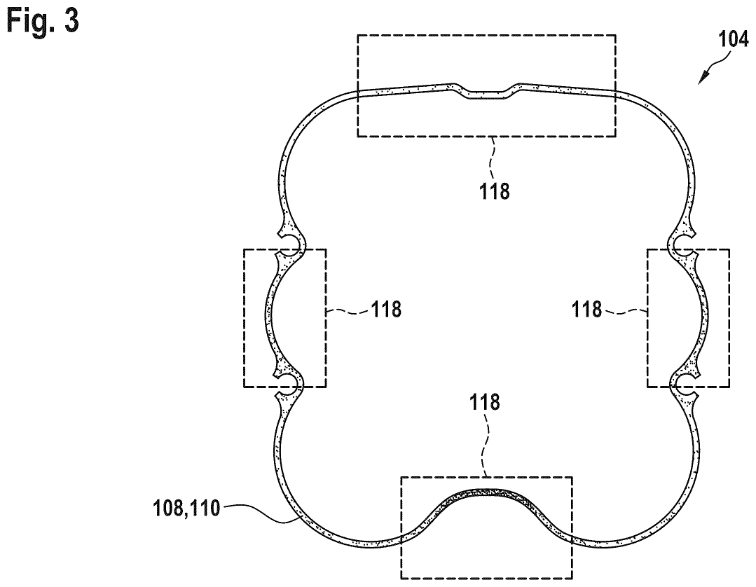

FIG. 3 shows a cross section through the housing 104, in particular through the base body 110. The base body 110 is, by way of example, made of a metallic material, in particular aluminum. The base body 110 has a thickness in the range of between 0.8 mm and 1.1 mm, by way of example 1.1 mm. The stiffness of the housing 104, in particular the housing portion 108 in the form of the base body 110, is reduced due to the thin wall.

Due to the reduced stiffness, the housing portion 108 comprises, by way of example, four regions 118 where increased deformation occurs in the mounted state.

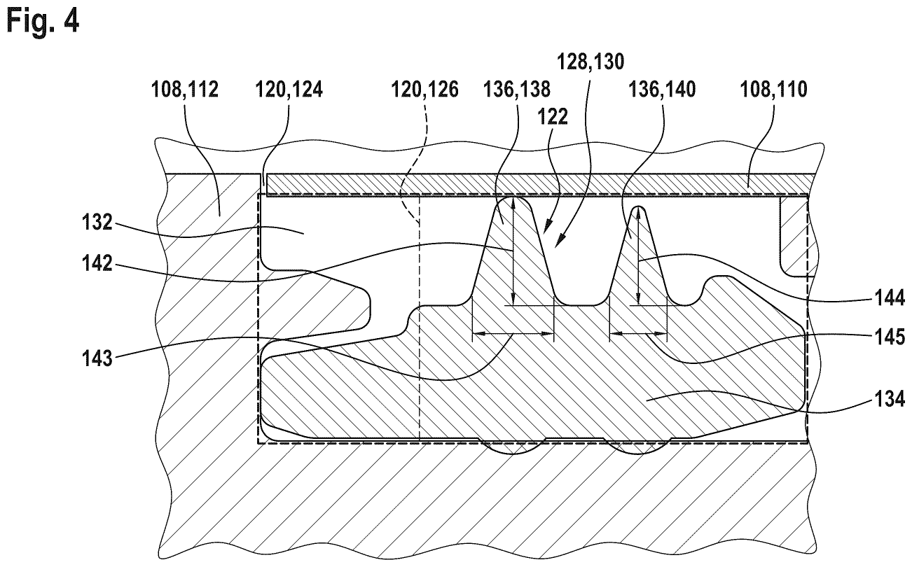

FIG. 4 shows a section through the two housing portions 108 in the form of the base body 110 and one of the connection plates 112. The connection of the housing portions 108 creates gaps 120 that are sealed via a sealing unit 122. The geometry of the housing portions 108 provides, by way of example, an axial gap 124 and a radial gap 126.

The seal unit 122 comprises a sealing element 128 designed to seal the gap 120, in particular the radial gap 126. The sealing element 128 is, by way of example, designed as a seal ring 130. The sealing element 128 is, by way of example, arranged substantially entirely in a receiving space 132 of the housing 104 between the two housing portions 108. In the embodiment shown, the sealing element 128 is designed for radial sealing, wherein Alternatively or additionally it is conceivable that the sealing element or another sealing element be designed for axial sealing.

The sealing element 128 comprises a substantially annular base body 134. The base body 134 extends along the entire radial gap 126.

The sealing element 128 further comprises exactly two seal lips 136. The seal lips 136 extend from the base body 134 of the sealing element 128, in particular in a radial direction. The seal lips 136 extend, by way of example, continuously along the entire circumference of the sealing element 128.

The first seal lip 138 is designed as a primary lip, wherein water penetrating from the outside through the gap 120 initially impacts the first seal lip 138 or the primary lip. The second seal lip 140 is designed as a secondary lip, wherein water penetrating from the outside through the gap 120 must first be fed past the primary lip before it meets the secondary lip. The downstream arrangement of the secondary lip exposes it to lower loads than the primary lip. Alternatively, it is also conceivable that the sealing element 128 comprise at least two second seal lips 140, or at least two secondary lips. The first seal lip 138 is formed in the mounted state. By way of example, the second seal lip 140 is not formed in the mounted state, wherein it is also conceivable that the second seal lip 140 be formed in the mounted state. In particular, the compression of the first seal lip 138 is greater than the compression of the second seal lip 140.

The first seal lip 138 has a first height 142 and a first width 143, which are different from a second height 144 and a second width 145 of the second seal lip 140. The first height 142 of the first seal lip 138 is, by way of example, approximately 10% greater than the second height 144 of the second seal lip 140. Also, the first width 143 of the first seal lip 138 is approximately 30% greater than the second width 145 of the second seal lip 140. In this context, the values refer to the uncompressed state, wherein the height is reduced by the compression and the width is increased by the compression.

The receiving space 132 in the region of the seal lips 138, 140 has in particular a substantially equal height so that, in the region of the second seal lip 140 in the mounted state, the force exerted by the housing 104 on the second seal lip 140 is always less than the force on the first seal lip 138.

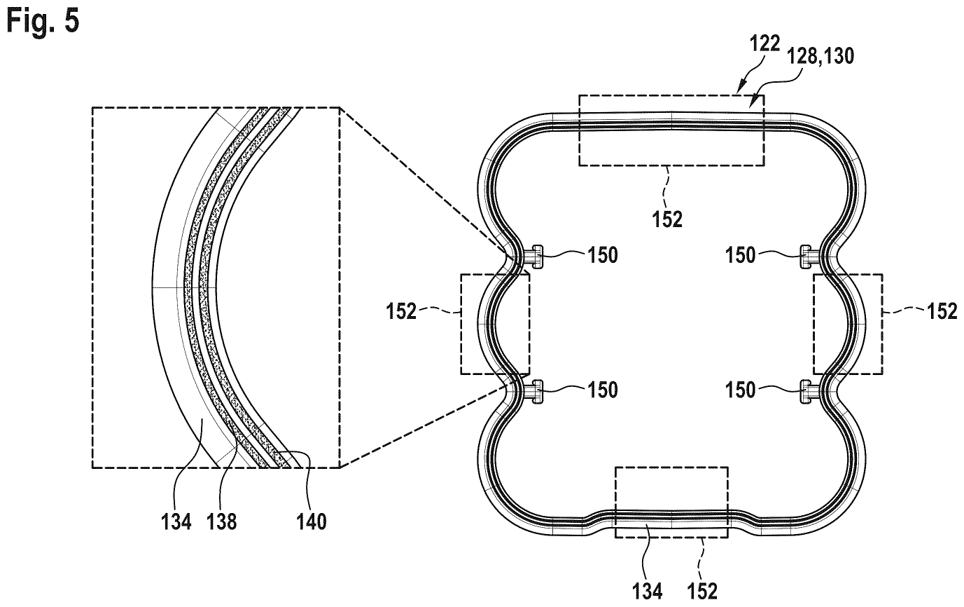

FIG. 5 shows an overhead view of the sealing element 128. The sealing element 128, in particular the base body 134 of the sealing element 128, extends substantially according to the cross-section of the base body 110 of the housing 104 of the battery pack 100 shown in FIG. 3.

The size, in particular the first height 142, of the first seal lip 138 is designed to vary. The sealing element 128 comprises coupling elements 150 that correspond to coupling elements (not shown) of the housing 104 of the battery pack 100 and retain the sealing element 128 during mounting to at least one housing piece 108. By way of example, the sealing element 128 comprises four connecting elements 150 that are T-shaped and extend inwardly from the base body 134 of the sealing element 128 perpendicular to the seal lips 138, 140.

Corresponding to the regions 118 of the housing 104 in which increased deformation of the housing 104 occurs, the sealing element 128 has regions 152 of an increased size, in particular an increased height. The enlargement is, by way of example, at a maximum of 20% centrally in the respective regions 152 of the sealing element 128.

The seal unit 124 comprises a second sealing element (not shown) that seals the housing 104 in the region of the other connection plate.

What is claimed is:

1. A battery pack, comprising:
a housing including at least two housing portions that define a receiving space therebetween; and
a sealing unit configured to seal the housing,
wherein the sealing unit includes at least one sealing element received in the receiving space, and
wherein the sealing element includes exactly two seal lips.

2. The battery pack according to claim 1, wherein the sealing element is arranged radially between the first housing portion and the second housing portion.

3. The battery pack according to claim 2, wherein the first housing portions are formed as a connecting plate, and the second housing portion is formed as a tubular base body.

4. The battery pack according to claim 1, wherein:
the exactly two seal lips include a first seal lip and a second seal lip, and
the second seal lip has a lower height than the first seal lip.

5. The battery pack according to claim 1, wherein:
the exactly two seal lips include a first seal lip and a second seal lip, and
the second seal lip has a smaller width than the first seal lip.

6. The battery pack according to claim 1, wherein:
the exactly two seal lips include a first seal lip and a second seal lip, and
a distance between the first seal lip and the second seal lip is designed to be smaller than a width of the first seal lip.

7. The battery pack according to claim 1, wherein the receiving space has a constant size in the region of the sealing element.

8. The battery pack according to claim 1, wherein the sealing element is enlarged in some areas.

9. The battery pack according to claim 8, wherein:
the exactly two seal lips include a first seal lip and a second seal lip, and
the enlargement of the first seal lip is designed to be in a range between 5% and 50%.

10. The battery pack according to claim 1, wherein:
the exactly two seal lips include a first seal lip and a second seal lip, and
the second seal lip varies in size.

11. The battery pack according to claim 1, wherein the sealing element comprises at least one connecting element for a frictional and/or interlocking connection between the sealing element and the first housing portion and/or the second housing portion.

12. The battery pack according to claim 1, wherein a single sealing element is arranged between two housing portions.

13. The battery pack according to claim 1, wherein the second housing portion is made of a metallic material and has a thickness of less than 1.1 mm.

14. The battery pack according to claim 1, wherein the second housing portion is made of a plastic material and has a thickness of less than 2.0 mm.

15. The battery pack according to claim 1, wherein the battery pack is an interchangeable battery pack.

16. The battery pack according to claim 1, wherein the receiving space has a constant size in the area of the first seal lip.

17. The battery pack according to claim 1, wherein the first seal lip is enlarged in some areas.

18. The battery pack according to claim 1, wherein the second housing portion is made of a metallic material and has a thickness of less than 0.8 mm.

19. The battery pack according to claim 1, wherein the second housing portion is made of a plastic material and has a thickness of less than 1.5 mm.

20. The battery pack according to claim 8, wherein:
the exactly two seal lips include a first seal lip and a second seal lip, and
the enlargement of the first seal lip is designed to be in a range between 10% and 20%.
